(19) United States
(12) Patent Application Publication
(10) Pub. No.: US 2025/0301363 A1
(43) Pub. Date: Sep. 25, 2025

(54) METHOD FOR SUPPORTING DETERMINISTIC NETWORKS IN A WIRELESS COMMUNICATIONS NETWORK

(71) Applicant: Lenovo (Singapore) Pte. Limited, Singapore (SG)

(72) Inventors: Dimitrios Karampatsis, Ruislip (GB); Emmanouil Pateromichelakis, Viersen (DE)

(73) Assignee: Lenovo (Singapore) Pte. Limited, Singapore (SG)

(21) Appl. No.: 18/862,789

(22) PCT Filed: Jun. 23, 2022
(86) PCT No.: PCT/EP2022/067105

§ 371 Date: Nov. 4, 2024

(30) Foreign Application Priority Data
May 4, 2022 (GR) 20220100366

(51) Int. Cl. H04W 28/02; H04L 41/12; H04W 76/10

(52) U.S. Cl. CPC H04W 28/0215; H04L 41/12; H04W 76/10

(57) ABSTRACT

There is provided a wireless communication device for communicating with a wireless communication network, the wireless communication device comprising a transceiver arranged to send a request to the wireless communication network, the request comprising a first information to setup a user plane connection for Deterministic Network traffic.

### FIELD

The subject matter disclosed herein relates generally to the field of implementing support for layer-3 Deterministic Networks in 5G systems.

### BACKGROUND

3GPP has defined support for Deterministic Networks since Release 17.

In Release 17, support of layer-2 Deterministic Networks (namely IEEE Time Sensitive Networking based on IEEE 802.1q standard) is supported.

Therefore, existing support for 3GPP systems to route Deterministic Network traffic is based on Ethernet/layer-2 based interfaces, whereas IETF networks use IP connectivity/layer-3 based interfaces.

### SUMMARY

A problem with suggested procedures for influencing a 3GPP system to set up a connection with specific Quality of Service requirement is that they do not provide functionality for a Deterministic Network controller to identify and/or discover suitable user equipment, and for the 3GPP network to be configured to support a suitable connection for deterministic traffic.

Disclosed herein are procedures for supporting layer-3 Deterministic Networks in 5G systems. Said procedures may be implemented by the apparatuses and architectures described herein.

There is provided a wireless communication device for communicating with a wireless communication network, the wireless communication device comprising a transceiver arranged to send a request to the wireless communication network, the request comprising a first information to setup a user plane connection for Deterministic Network traffic.

There is further provided a method in a wireless communication device, the wireless communication device arranged to communicate with a wireless communication network, the method comprising sending a request to the wireless communication network, the request comprising a first information to setup a user plane connection for Deterministic Network traffic.

There is further provided an application function in a wireless communication network, the application function comprising a transceiver and a processor. The transceiver is arranged to: send a subscription request to a first network function of the wireless communication network, the subscription request requesting a notification of the network address of a device when the device establishes a user plane connection to support Deterministic Network deterministic traffic; receive from the first network function first information, the first information identifying a first device, and the first information identifying a second network function supporting Deterministic Network relay node functionality; receive from a Deterministic Network controller in response to receiving the first information, Deterministic Network flow requirements. The processor is arranged to translate Deterministic Network flow requirements into Quality of Service requirements for relaying Deterministic Network traffic over the wireless communication network. The transceiver is further arranged to send a second request to the second network function to establish a user plane session with the wireless communication network in accordance with the Quality of Service requirements for relaying Deterministic Network traffic over the wireless communication network.

There is further provided a method in an application function of a wireless communication network. The method comprises sending a subscription request to a first network function of the wireless communication network, the subscription request requesting a notification of the network address of a device when the device establishes a user plane connection to support Deterministic Network deterministic traffic; and receiving from the first network function first information, the first information identifying a first device, and the first information identifying a second network function supporting Deterministic Network relay node functionality. The method further comprises receiving from a Deterministic Network controller in response to the first information Deterministic Network flow requirements; and translating the Deterministic Network flow requirements into Quality of Service requirements for relaying Deterministic Network traffic over the wireless communication network. The method further comprises sending a second request to the second network function to establish a user plane session with the wireless communication network in accordance with the Quality of Service requirements for relaying Deterministic Network traffic over the wireless communication network.

There is further provided a first network function in a wireless communication network, the first network function comprising a transceiver. The transceiver is arranged to: receive a subscription request from an application function of the wireless communication network, the subscription request requesting a notification of the network address of a device when the device establishes a user plane connection to support Deterministic Network deterministic traffic; and send to the application function a first information, the first information identifying a first device, and the first information identifying a second network function supporting Deterministic Network relay node functionality.

There is further provided a method in a first network function of a wireless communication network. The method comprises receiving a subscription request from an application function of the wireless communication network, the subscription request requesting a notification of the network address of a device when the device establishes a user plane connection to support Deterministic Network deterministic traffic. The method further comprises sending to the application function a first information, the first information identifying a first device, and the first information identifying a second network function supporting Deterministic Network relay node functionality.

There is further provided a user plane function in a wireless communication network, the user plane function comprising a transceiver. The transceiver is arranged to receive from a session management function a request to establish a user plane session with the wireless communication network in accordance with at least one Quality of Service requirement for relaying Deterministic Network traffic over the wireless communication network. The transceiver is further arranged to transmit a response to the session management function indicating first information including a Deterministic Network capability of the user plane function.

There is further provided a method in a user plane function of a wireless communication network. The method comprises receiving from a session management function a request to establish a user plane session with the wireless communication network in accordance with at least one Quality of Service requirement for relaying Deterministic Network traffic over the wireless communication network. The method further comprises transmitting a response to the session management function indicating first information including a Deterministic Network capability of the user plane function.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatuses for supporting layer-3 Deterministic Networks in 5G systems will now be described, by way of example only, with reference to the accompanying drawings, in which:

FIG. 1 is a schematic illustration of a network architecture to support a IEEE Time-Sensitive Networking system in a 5G system;

FIG. 2 is a schematic illustration of a network architecture to support IETF Deterministic Networks;

FIG. 3 is a schematic illustration of a further network architecture to support IETF Deterministic Networks;

FIG. 4 is a schematic illustration of a user equipment apparatus that may be used for implementing the methods described herein;

FIG. 5 is a schematic illustration of a network node that may be used for implementing the methods described herein;

FIG. 6 is a schematic illustration of a yet further network architecture to support IETF Deterministic Network relay nodes in a 5G system;

FIG. 7 is a schematic depiction of a procedure for establishing a PDU Session for relaying Deterministic Network flows;

FIG. 8 is a schematic depiction of a procedure for configuring a 5G system with appropriate Quality of Service characteristics;

FIG. 9 is a schematic depiction of a further procedure for routing a Deterministic Network flow packet via a Deterministic Network-aware 5G system;

FIG. 10 is a schematic illustration of a yet further still network architecture to support Deterministic Network flow via a Deterministic Network-unaware 5G system;

FIG. 11 is a process flow chart depicting a method performed by a wireless communication device in a wireless communication network;

FIG. 12 is a process flow chart depicting a further method performed by an Application Function of the wireless communication network;

FIG. 13 is a process flow chart depicting a yet further method performed by a first Network Function of the wireless communication network; and

FIG. 14 is a process flow chart depicting a yet further method performed by a User Plane Function of the wireless communication network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

3GPP has defined support of deterministic networks since Release 17. In Release 17, support of layer-2 deterministic networks (namely IEEE Time Sensitive Networking based on the IEEE 802.1Q standard) is supported.

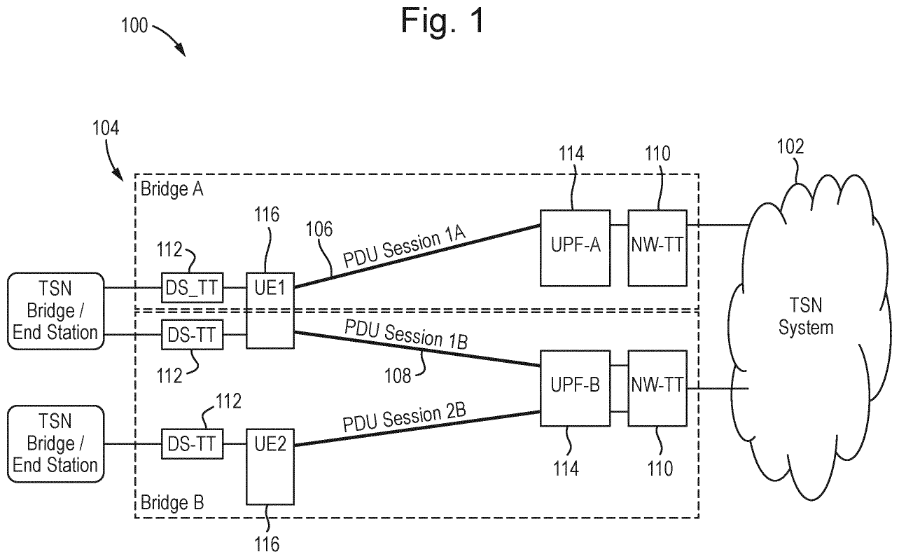

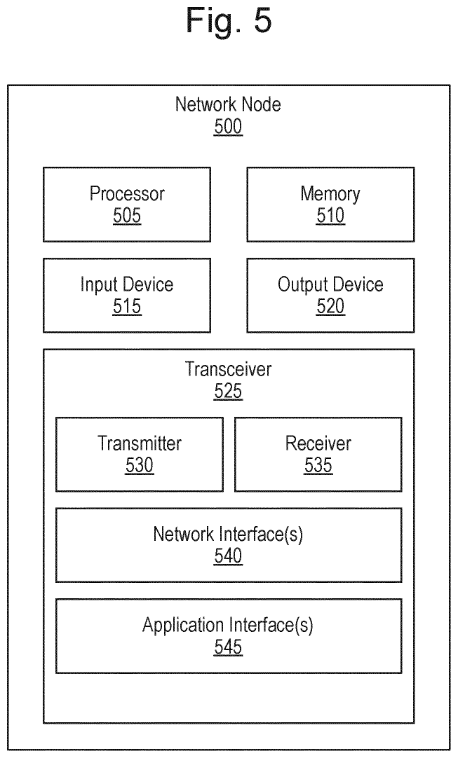

To support IEEE Time-Sensitive Networking (TSN), a 5GS system is configured as a layer-2 bridge as shown in FIG. 1. FIG. 1 is identical to FIG. 5.28.1-1 of 3GPP TS 23.501 v 17.4.0 and depicts a network architecture 100 to support a IEEE TSN system 102 in a 5G system (5GS).

In order to support TSN-scheduled traffic (clause 8.6.8.4 in IEEE Std 802.1Q-2018 [98]) over a 5GS Bridge 104, the 5GS supports the following functions:
Configuring bridge information in the 5GS.
Reporting the bridge information of the 5GS Bridge 104 to the TSN network 102 after establishment of a Protocol Data Unit (PDU) session 106.
Receiving configuration information from TSN network 102.
Mapping the configuration information obtained from the TSN network into 5GS Quality of Service (QOS) information (e.g. 5QI, Time-Sensitive Communications (TSC) Assistance Information) of a QoS Flow in a corresponding PDU Session 108 for efficient time-aware scheduling.

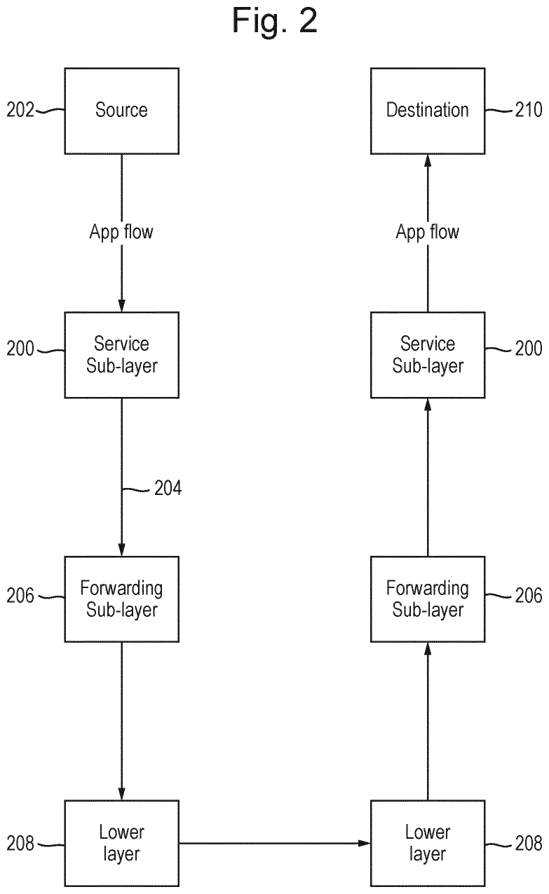

Network Side TSN Translator (NW-TT) 110 and Device Side TSN Translator (DS-TT) 112 functions located at a User Plane Function (UPF) 114 and user equipment apparatus (UE) 116, respectively, are responsible for calculating a propagation delay within the 5GS, which propagation delay is used to adjust a time synchronization clock. As part of Release 18, a new study was agreed in order to support layer-3 deterministic networks (in particular, the IETF DetNet standard was agreed as described in IETF RFC 8938) within the 5GS system. A very basic depiction of the IETF DetNet support is shown in FIG. 2. FIG. 2 depicts, in particular, a deterministic network (DetNet) aware node, i.e. a Service Sub-layer 200, which receives application packets from a source 202 (which is DetNet unaware) and encapsulates the packet into a DetNet flow 204 that has particular deterministic characteristics (e.g. a specific QoS, delay tolerance, etc.). The DetNet aware node 200 encapsulates the packet into the DetNet flow 204 based on information (rules) provided by a DetNet controller (not shown in FIG. 2). The rules are in the form of a DetNet Yang model, as described in draft-ietf-detnet-yang-16. This document contains the specification for configuration and operational data for DetNet flows such as the DetNet flow 204.

The DetNet flow can re-use existing headers in the app flow from the source 202, or can use other headers added at the Service Sub-layer 200. The header may include a DetNet Flow ID and may be sequenced as metadata or as a packet header.

The DetNet flow 204 is received by a Forwarding Sub-layer 206, and forwarded to a Lower layer 208 before making a return journey via a Forwarding Sub-layer 206 and a Service Sub-layer 200 to a destination 210.

At the Forwarding Sub-layer 106, resources for the DetNet flow are allocated to explicit routes as per RFC8938.

The presently disclosed arrangements involve the following assumptions:
Only IP-based DetNet is in the scope of the work; Multiprotocol Label Switching (MPLS)-based DetNet is out of its scope.
IP-based DetNet traffic is carried in PDU Sessions of IP type. (DetNet over Ethernet TSN is not in the scope of the work as it can be supported based on existing 3GPP and IETF standards.)
The solutions should re-use the functionality of the TSC framework defined in Release 17 where applicable.
The solutions support a request from the DetNet controller entity including DetNet configuration for flow path establishment.
Since synchronization mechanisms that can be used are out of the scope of IETF DetNet specifications, the time synchronization framework in Release 17 is not modified.
Existing 3GPP routing mechanisms can be re-used for DetNet; no new routing function in the 3GPP system is to be defined.
Existing filtering mechanisms can be re-used in the UE 116 and in the UPF 114 to identify the traffic for QOS differentiation.

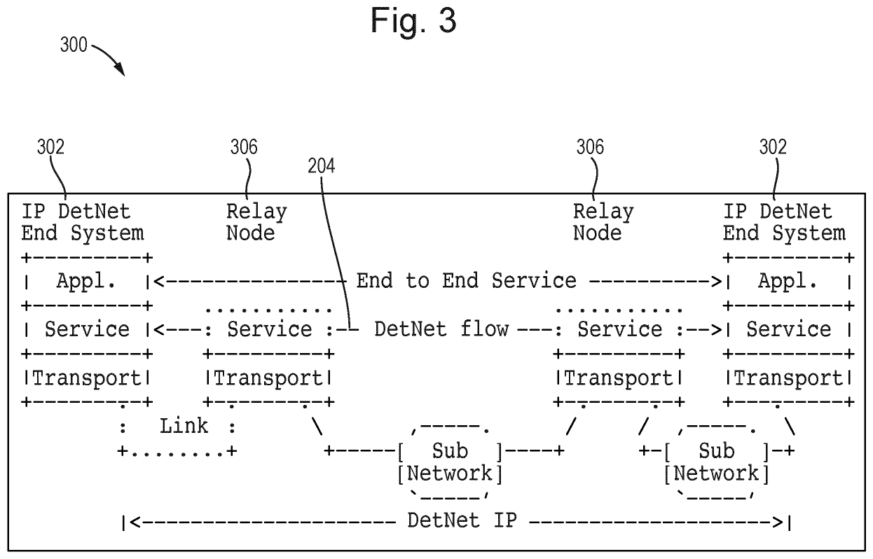

Based on the SID objectives, the following IETF DetNet implementation is supported where service nodes of the network are configured as a relay 300, as shown in FIG. 3.

The IETF DetNet end system 302 may have already encapsulated one or more application flows into the DetNet flow 204 and thus a relay node 304 forwards the DetNet flow 204 according to the DetNet flow deterministic characteristics, as configured from a DetNet controller (not shown in FIG. 3).

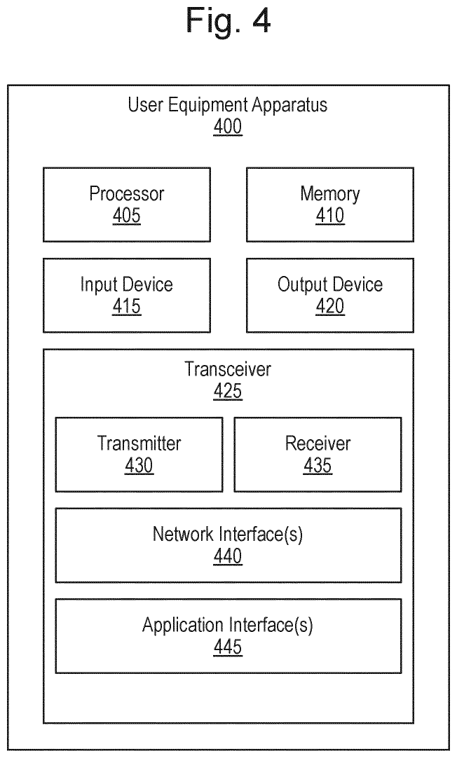

FIG. 4 depicts a UE 400 that may be used for implementing the methods described herein. The UE 400 is used to implement one or more of the solutions described herein. The UE 400 is in accordance with one or more of the UEs described in embodiments herein. In particular, the UE 400 is in accordance with UE 116, and as such the reference numeral 400 is used hereinafter to indicate a UE in accordance with the UE 116. The UE 400 includes a processor 405, a memory 410, an input device 415, an output device 420, and a transceiver 425.

The input device 415 and the output device 420 may be combined into a single device, such as a touchscreen. In some implementations, the UE 400 does not include any input device 415 and/or output device 420. The UE 400 may include one or more of: the processor 405, the memory 410, and the transceiver 425, and may not include the input device 415 and/or the output device 420.

As depicted, the transceiver 425 includes at least one transmitter 430 and at least one receiver 435. The transceiver 425 may communicate with one or more cells (or wireless coverage areas) supported by one or more base units. The transceiver 425 may be operable on unlicensed spectrum. Moreover, the transceiver 425 may include multiple UE panels supporting one or more beams. Additionally, the transceiver 425 may support at least one network interface 440 and/or application interface 445. The application interface(s) 445 may support one or more APIs. The network interface(s) 440 may support 3GPP reference points, such as Uu, N1, PC5, etc. Other network interfaces 440 may be supported, as understood by one of ordinary skill in the art.

The processor 405 may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. The processor 405 may execute instructions stored in the memory 410 to perform the methods and routines described herein. The processor 405 is communicatively coupled to the memory 410, the input device 415, the output device 420, and the transceiver 425.

The processor 405 may control the UE 400 to implement the UE behaviors described herein. The processor 405 may include an application processor (also known as “main processor”) which manages application-domain and operating system (“OS”) functions and a baseband processor (also known as “baseband radio processor”) which manages radio functions.

The memory 410 may be a computer readable storage medium. The memory 410 may include volatile computer storage media. For example, the memory 410 may include a RAM, including dynamic RAM (“DRAM”), synchronous dynamic RAM (“SDRAM”), and/or static RAM (“SRAM”). The memory 410 may include non-volatile computer storage media. For example, the memory 410 may include a hard disk drive, a flash memory, or any other suitable non-volatile computer storage device. The memory 410 may include both volatile and non-volatile computer storage media.

The memory 410 may store data related to implement a traffic category field as described herein. The memory 410 may also store program code and related data, such as an operating system or other controller algorithms operating on the UE 400.

The input device 415 may include any known computer input device including a touch panel, a button, a keyboard, a stylus, a microphone, or the like. The input device 415 may be integrated with the output device 420, for example, as a touchscreen or similar touch-sensitive display. The input device 415 may include a touchscreen such that text may be input using a virtual keyboard displayed on the touchscreen and/or by handwriting on the touchscreen. The input device 415 may include two or more different devices, such as a keyboard and a touch panel.

The output device 420 may be designed to output visual, audible, and/or haptic signals. The output device 420 may include an electronically controllable display or display device capable of outputting visual data to a user. For example, the output device 420 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 420 may include a wearable display separate from, but communicatively coupled to, the rest of the user equipment apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

The output device 420 may include one or more speakers for producing sound. For example, the output device 420 may produce an audible alert or notification (e.g., a beep or chime). The output device 420 may include one or more haptic devices for producing vibrations, motion, or other haptic feedback. All, or portions, of the output device 420 may be integrated with the input device 415. For example, the input device 415 and output device 420 may form a touchscreen or similar touch-sensitive display. The output device 420 may be located near the input device 415.

The transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver 425 (or portions thereof) at particular times in order to send and receive messages.

The transceiver 425 includes at least one transmitter 430 and at least one receiver 435. The one or more transmitters 430 may be used to provide uplink communication signals to a base unit of a wireless communications network. Similarly, the one or more receivers 435 may be used to receive downlink communication signals from the base unit. Although only one transmitter 430 and one receiver 435 are illustrated, the UE 400 may have any suitable number of transmitters 430 and receivers 435. Further, the transmitter(s) 430 and the receiver(s) 435 may be any suitable type of transmitters and receivers. The transceiver 425 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

One or more transmitters 430 and/or one or more receivers 435 may be implemented and/or integrated into a single hardware component, such as a multi-transceiver chip, a system-on-a-chip, an Application-Specific Integrated Circuit (“ASIC”), or other type of hardware component. One or more transmitters 430 and/or one or more receivers 435 may be implemented and/or integrated into a multi-chip module. Other components such as the network interface 440 or other hardware components/circuits may be integrated with any number of transmitters 430 and/or receivers 435 into a single chip. The transmitters 430 and receivers 435 may be logically configured as a transceiver 425 that uses one more common control signals or as modular transmitters 430 and receivers 435 implemented in the same hardware chip or in a multi-chip module.

FIG. 5 depicts further details of the network node 500 that may be used for implementing the methods described herein. The network node 300 may be one implementation of an entity in the wireless communications network, e.g. in one or more of the wireless communications networks described herein. The network node 500 may be, for example, the UE 400 described above, or a Network Function (NF) or Application Function (AF), or another entity, of one or more of the wireless communications networks of embodiments described herein. The network node 500 includes a processor 505, a memory 510, an input device 515, an output device 520, and a transceiver 525.

The input device 515 and the output device 520 may be combined into a single device, such as a touchscreen. In some implementations, the network node 500 does not include any input device 515 and/or output device 520. The network node 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more remote units 400. Additionally, the transceiver 525 may support at least one network interface 540 and/or application interface 545. The application interface(s) 545 may support one or more APIs. The network interface(s) 540 may support 3GPP reference points, such as Uu, N1, N2 and N3. Other network interfaces 540 may be supported, as understood by one of ordinary skill in the art.

The processor 505 may include any known controller capable of executing computer-readable instructions and/or capable of performing logical operations. For example, the processor 505 may be a microcontroller, a microprocessor, a CPU, a GPU, an auxiliary processing unit, a FPGA, or similar programmable controller. The processor 505 may execute instructions stored in the memory 510 to perform the methods and routines described herein. The processor 305 is communicatively coupled to the memory 510, the input device 515, the output device 520, and the transceiver 525.

The memory 510 may be a computer readable storage medium. The memory 510 may include volatile computer storage media. For example, the memory 510 may include a RAM, including dynamic RAM (“DRAM”), synchronous dynamic RAM (“SDRAM”), and/or static RAM (“SRAM”). The memory 510 may include non-volatile computer storage media. For example, the memory 510 may include a hard disk drive, a flash memory, or any other suitable non-volatile computer storage device. The memory 510 may include both volatile and non-volatile computer storage media.

The memory 510 may store data related to establishing a multipath unicast link and/or mobile operation. For example, the memory 510 may store parameters, configurations, resource assignments, policies, and the like, as described herein. The memory 510 may also stores program code and related data, such as an operating system or other controller algorithms operating on the network node 500.

The input device 515 may include any known computer input device including a touch panel, a button, a keyboard, a stylus, a microphone, or the like. The input device 515 may be integrated with the output device 520, for example, as a touchscreen or similar touch-sensitive display. The input device 515 may include a touchscreen such that text may be input using a virtual keyboard displayed on the touchscreen and/or by handwriting on the touchscreen. The input device 515 may include two or more different devices, such as a keyboard and a touch panel.

The output device 520 may be designed to output visual, audible, and/or haptic signals. The output device 520 may include an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the network node 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

The output device 520 may include one or more speakers for producing sound. For example, the output device 520 may produce an audible alert or notification (e.g., a beep or chime). The output device 520 may include one or more haptic devices for producing vibrations, motion, or other haptic feedback. All, or portions, of the output device 520 may be integrated with the input device 515. For example, the input device 515 and output device 520 may form a touchscreen or similar touch-sensitive display. The output device 520 may be located near the input device 515.

The transceiver 525 includes at least one transmitter 530 and at least one receiver 535. The one or more transmitters 530 may be used to communicate with the UE 400, as described herein. Similarly, the one or more receivers 335 may be used to communicate with network functions in the PLMN and/or RAN, as described herein. Although only one transmitter 530 and one receiver 535 are illustrated, the network node 500 may have any suitable number of transmitters 530 and receivers 535. Further, the transmitter(s) 530 and the receiver(s) 535 may be any suitable type of transmitters and receivers.

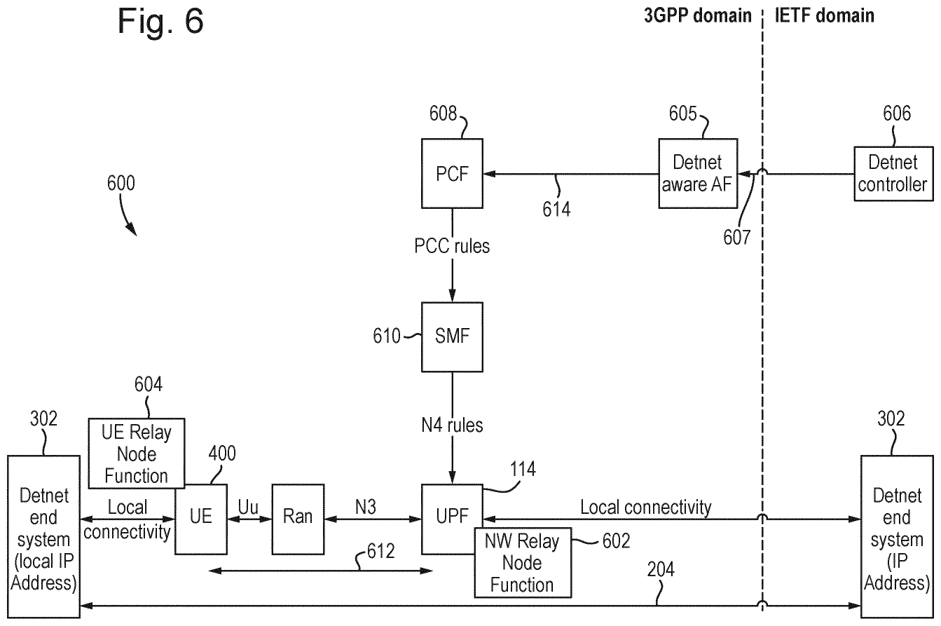

An architecture 600 proposed to support IETF DetNet relay nodes 306 in a 5GS as shown in FIG. 3 is illustrated in FIG. 6, which depicts using relay nodes 306 to support IETF DetNet flows 204.

In this embodiment, each 3GPP node (e.g., the UE 400, the UPF 114, etc.) that is used to route user plane traffic can be configured to act as a DetNet relay node 306. The UPF 114 may include, or be considered, a NW relay node 114, which supports a NW Relay Node Function 602, and the UE 400 may support a UE Relay Node Function 604, as shown in FIG. 6.

The NW Relay Node function 602 and UE Relay Node function 604 are DetNet-aware and receive configuration (from a DetNet controller) as to how to handle DetNet flows 204.

The NW relay node 114 and UE relay node may reside outside of, respectively, the UE 400 and UPF 114, i.e. as separate functions 602, 604, or said relay nodes 114, 400 may be collocated. In addition, it is possible that the 5GS supports only one relay node 306, i.e. supports only the UE relay node 400 or the NW relay node 114 relay node, depending on the implementation.

It is proposed to re-use, as much as possible, the IEEE TSN functionality of the 5GS system, wherein a DetNet-aware AF 605 receives configuration information from the DetNet controller 606 (located outside of the 3GPP domain) in the form of DetNet Yang traffic profiles, and converts, said configuration information into TSC assistance information containing QoS information which is sent to a Policy Control Function (PCF) 608 within the 3GPP system. The PCF 608 determines Policy and Charging Control (PCC) rules based on the QoS information, and instructs a Session Management Function (SMF) 610 to configure the UE's PDU session, to be used for DetNet flows 204, to support the QoS characteristics of said DetNet flows 204.

Receipt by the DetNet-aware AF 605 of configuration information is indicated in FIG. 6 by a single-headed arrow and the reference numeral 607.

In order to support the architecture proposed in FIG. 6, the following need to take place:
Configuration of the UE 400 to be used as a relay node 306 and establish a PDU session 612 for DetNet flows 204. One option is that the UE 400 is pre-configured with DetNet relay node configuration.
Reporting, to the DetNet controller 606, IETF DetNet relay node support (i.e. the IP address of the UE 400 used as a relay node 306).
Discovery of DetNet end systems 302 located behind the relay nodes 306. (This may be optional in case-specific DetNet end systems which interface with specific UEs supporting DetNet relay nodes).
Determination of a propagation delay within the 5GS when transmitting DetNet flows 204.
Receipt by a DetNet-aware AF 605 of the DetNet flow configuration from the DetNet controller 606. The DetNet controller 606 may take into account the propagation delay reported by the 5GS.
Mapping of the DetNet flow configuration information, including application flows and traffic profiles, obtained by the DetNet-aware AF 605 from the DetNet controller 606 into 5GS QOS information (e.g. 5QI, TSC Assistance Information) of a QoS flow in the corresponding PDU Session 612 for DetNet flows 204. More than one application flow may map to the same DetNet flow 204. Mapping of the DetNet flow configuration information by the DetNet-aware AF 605 into 5GS QoS information of a QoS flow is indicated in FIG. 6 by a single-headed arrow and the reference numeral 614.
Establishment, by the UE 400, of the PDU session 612 for relaying DetNet flows 204, as shown in FIG. 7.

FIG. 7 depicts a procedure 700 for establishing the PDU Session 612 for relaying DetNet flows 204.

The UE 400 that is DetNet-aware (i.e. operating as a relay node) is triggered (based on configuration information) to establish the PDU Session 612 for relaying DetNet flows 204. The UE 400 is pre-configured to act as a DetNet-aware node, i.e. a relay node 306. The UE 400 can be configured to establish a dual connection by setting up two redundant PDU sessions over the 5G network. The UE 400 may use the duplicate paths for supporting redundancy of a DetNet flow 204 according to DetNet flow requirements.

The establishing the PDU Session 612 by the UE 400 is indicated in FIG. 7 by the reference numeral 702.

In this embodiment, the UE 400 includes, in a PDU session establishment, to be sent to the SMF 610 via an Access and Mobility Management (AMF) 704, a requested S-NSSAI, DNN and, optionally, a DetNet capability indication. The S-NSSAI, DNN and DetNet capability may be included outside of the Session Management (SM) container including the PDU session establishment request such that the AMF 704 can select an appropriate SMF 610 for supporting DetNet flows. UL Non-Access Stratum (NAS) transport (S-NSSAI/DNN, DetNet capability indication, SM container PDU Session establishment (including the DNN, S-NSSAI, and optionally DetNet capability)) from the UE 400 to the AMF 704 is indicated in FIG. 7 by a single-headed arrow and the reference numeral 706

The DetNet capability indication may include information indicating:
Support of Relay, Edge, and/or Transit Nodes;
Support of protocols for receiving a DetNet configuration (e.g. NETCONF RFC6241/YANG RFC6020 or PRE-CC RFC 8283);
Resident time information (i.e. time for the UE Relay Node 604 to process a DetNet flow 204). Device-side TSN translator (DS TT) functionality as defined in 3GPP TS 23.501 v 17.4.0 may be re-used for this purpose.

In this embodiment, the AMF 704 receives the request and selects a TSC-aware SMF 610 based on the S-NSSAI/DNN requested and/or the DetNet capability indication if received from the UE 400. The selecting of the TSC-aware SMF 610 by the AMF 704 is indicated in FIG. 7 by the reference numeral 708.

In this embodiment, the AMF 704 sends a Create Session Establishment request to the SMF 610, including the SM container received at 706. Sending of the Create Session Establishment request to the SMF 610 by the AMF 704 is indicated in FIG. 7 by a single-headed arrow and the reference numeral 710.

In this embodiment, the SMF 610 selects the PCF 608 with which to establish a SM Policy Association, and establishes said SM Policy Association with the PCF 608. The establishing by the SMF 610 of a SM Policy Association with the PCF 608 is indicated in FIG. 7 with a double-headed arrow and the reference numeral 712.

In this embodiment, the SMF 610 selects the DetNet-capable UPF 114 (i.e. the UPF 114 supporting relaying of DetNet flows) based on the S-NSSAI/DNN and/or DetNet capability indication. The SMF 610 may interface with a Network Repository Function (NRF) to discover the DetNet-capable UPF 114 based on the S-NSSAI/DNN and/or DetNet capability indication. If the UE 400 requested two PDU Sessions for redundancy, the SMF 610 ensures that separate N3 tunnels are established to the selected UPF 114. The selecting by the SMF 610 of the DetNet-capable UPF 114 is indicated in FIG. 7 by the reference numeral 714.

In this embodiment, the SMF 610 acknowledges the request to the AMF 704. The sending by the SMF 610 the acknowledgement response to the AMF 704 is indicated in FIG. 7 by a single-headed arrow and the reference numeral 716.

In this embodiment, the SMF 610 initiates an N4 session establishment including rules for establishing the PDU Session 612. During this procedure, the UPF 714 may provide the DetNet capability information which includes the following information.
Support of Relay, Edge, and/or Transit Nodes;
Support of protocols for receiving a DetNet configuration (e.g. NETCONF RFC6241/YANG RFC6020 or PRE-CC RFC 8283);
Resident time information (i.e. time that the NW Relay Node processes a DetNet flow 204). Network-side TSN translator (NW TT) functionality as defined in 3GPP TS 23.501 v 17.4.0 may be re-used for this purpose.

The initiating the N4 session establishment by the SMF 610 is indicated in FIG. 7 by the double-headed arrow and the defence numeral 718.

In this embodiment, the SMF 610 sends a PDU Session Accept message to the UE 400 via the AMF 704. The sending the PDU Session Accept message to the UE 400 by the SMF 610 is indicated in FIG. 7 by single-headed arrows and the respective reference numerals 720, 722.

In this embodiment, based on a subscription from the PCF 608 (via the AF 605), the SMF 610 provides the DetNet capabilities and IP addresses of the UE 400 and UPF 114 to the PCF 608. The providing the DetNet capabilities and IP addresses of the UE 400 and UPF 114 to the PCF 608 is indicated in FIG. 7 by a double-headed arrow and the reference numeral 724.

In this embodiment, the PCF 608 forwards, i.e. reports, the information to the DetNet-aware AF 605 by invoking an Npcf_PolicyAuthorization_Notify. The forwarding/reporting of the information by the PCF 608 to the DetNet-aware AF 605 is indicated in FIG. 7 by a double-headed arrow and the reference numeral 726.

In this embodiment, the DetNet-aware AF 605 learns the IP addresses of the UE 400 and UPF 114 and potential latency of the DetNet flow 204 to traverse the 5GS (i.e. between UE 400 and the UPF 114). The learning by the DetNet-aware AF 605 of the IP addresses of the UE 400 and UPF 114 and potential latency of the DetNet flow 204 is indicated in FIG. 7 by the reference numeral 728.

In an alternative embodiment, the DetNet controller 606 is aware of the IP address of the UE 400 used as a DetNet relay node 306 by subscribing (from an AF) to the 5GS via a Network Exposure Function (NEF) to PDU Session status requests, including in the subscription request the S-NSSAI/DNN (of the slice or DNN used for DetNet flows) and/or a DetNet capability indication. The procedure is as described in FIG. 4.15.3.2.3-1 in 3GPP TS 23.502 v 17.4.0.

In this embodiment, once the DetNet controller 606/DetNet-aware AF 605 is aware of the IP address of the UE 400, the DetNet controller 606/DetNet-aware AF 605 can use a neighbour discovery protocol as per IETF RFC 4861 to discover DetNet end systems 302 located behind the UE 400 and the UPF 114.

In this embodiment, the DetNet controller 606 or DetNet-aware AF 605 can then determine the QoS characteristics for sending DetNet flows 204 between DetNet end systems 302. The DetNet controller 606 takes into account the latency within the 5GS as reported by the UE 400 and UPF 114.

Alternatively, the DetNet-aware AF 605 determines DetNet-specific TSC Assistance Information taking into account the characteristics of the DetNet flow 204 according to the information provided by the DetNet controller 606 in a DetNet Yang model configuration profile, as defined in draft-ietf-detnet-yang-16. In the Yang model, each DetNet flow 204 (associated with an ingress and an egress node) is associated to a traffic profile containing the following information:
Minimum bandwidth: this is the minimum bandwidth that has to be guaranteed for provision of the DetNet service.
Maximum latency: this is the maximum latency from ingress to egress node, in nanoseconds.
Maximum latency variation: this is the difference between the minimum and maximum end-end one-way latency, in nanoseconds.
MaxLoss: this defines the maximum Packet Loss Ratio (PLR) parameter for the DetNet service between the ingress and egress(es) of the DetNet domain.
MaxConsecutiveLossTolerance: this is the maximum consecutive loss tolerance parameter, which describes the maximum number of consecutive packets whose loss can be tolerated.
MaxMisordering: this describes the tolerable maximum number of packets that can be received out of order.
Max-pkts-per-interval: this is the maximum number of packets that the source will transmit in one interval.
Leaf max-payload-size: this is the maximum payload size that the source will transmit.
Min-payload-size: this is the minimum payload size that the source will transmit.
Leaf min-pkts-per-interval: this is the minimum number of packets that the source will transmit in one interval.

In this embodiment, based on the traffic profile information, the DetNet-aware AF 605 determines the following TSC Assistance Information as shown in the table below.

TABLE 1
TSC Assistance Information for the DetNet flow.

| Assistance | |
|---|---|
| Information | Description |
| Flow Direction | The direction of the DetNet flow (uplink or downlink). |
| QoS reference | A reference to the guaranteed QoS required based on the |
| | minimum bandwidth, maximum latency, maximum latency |
| | variation, MaxLoss in the DetNet Yang traffic profile |
| Periodicity | Refers to the time period between start of two bursts based on the |
| | max and min packets per interval information in the DetNet Yang |
| | traffic profile |
| Burst Arrival time | The latest possible time when the first packet of the data burst |
| | arrives at either the ingress of the RAN (downlink flow direction) or |
| | egress interface of the UE (uplink flow direction) based on the |
| | MaxMisordering information in the DetNet Yang traffic profile. |
| Survival Time | Based on the MaxConsecutiveLossTolerance information in the |
| | DetNet Yang traffic profile |

Alternatively, the TSC Assistance Information includes all traffic profile parameters contained in the DetNet Yang model traffic profile.

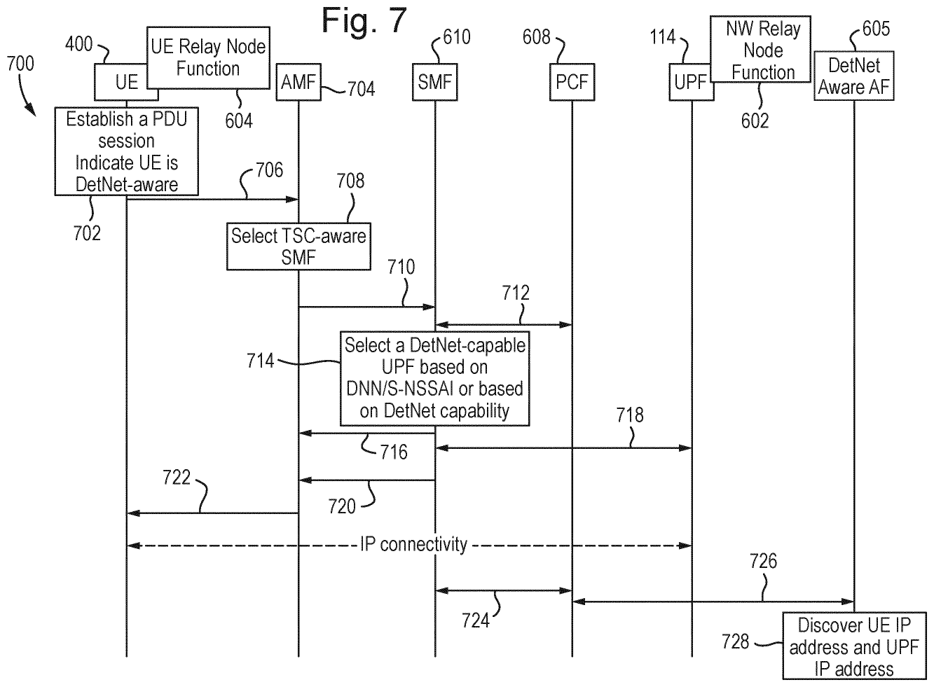

FIG. 8 depicts a procedure 800 for configuring the 5GS with appropriate QoS characteristics.

The UE 400 establishes a PDU Session 612 for DetNet flows 204, as shown in FIG. 6. The establishing the PDU Session 612 for DetNet flows 204 by the UE 400 is indicated in FIG. 8 by the reference numeral 802.

In this embodiment, the DetNet controller 606 subscribes via the AF 605 to be informed of DetNet nodes in the 3GPP system. In one embodiment, the AF 605 subscribes to PDU Session status events for a specific S-NSSAI/DNN (used for the DetNet flows 204) and/or a DetNet capability. The subscribing by the AF 605 to PDU Session status events and/or a DetNet capability is indicated in FIG. 8 by the reference numeral 804.

In an alternative embodiment, the AF 605 subscribes to a new Event ID. The DetNet controller 606 discovers the IP address of the UE 400 used as a DetNet relay node 306 and potential latency when the DetNet flow 204 is routed via the DetNet relay nodes 306 in the 5GS.

Returning to the embodiment of FIG. 8, the DetNet controller 606 discovers the DetNet end systems 302 that interface with the UE 400 acting as a DetNet relay node 306 using procedures out of the scope of 3GPP. For example, the DetNet controller 606 can use a neighbour discovery protocol as per IETF RFC 4861 to discover DetNet end systems 302 located behind the UE 400 and the UPF 114. The discovering by the DetNet controller 606 of the DetNet end systems 302 is indicated in FIG. 8 by the reference numeral 806.

In this embodiment, the DetNet controller 606 provides to a DetNet-aware AF 605 the configuration information of the DetNet flow 204 by providing the rules in the form of a DetNet Yang model, as described in draft-ietf-detnet-yang-16. This procedure is out of the scope of 3GPP. The providing by the DetNet controller 606 of the configuration information of the DetNet flow 204 to the DetNet-aware AF 605 is indicated in FIG. 8 by a single-headed arrow and the reference numeral 808.

In this embodiment, the DetNet-aware AF 605 derives DetNet-specific TSC Assistance Information including the QoS characteristics from the DetNet configuration information provided by the DetNet controller 606 based on the IETF DetNet Yang profile. The deriving by the DetNet-aware AF 605 of DetNet-specific TSC Assistance Information is indicated in FIG. 8 by the reference numeral 810.

In this embodiment, the DetNet-aware AF 605 sends a request to the NEF 808 to establish an AF session with a required QoS, the request including the UE IP address and TSC assistance information, along with DetNet specific parameters and/or an indication to establish a QoS flow for DetNet flow 204. The sending by the DetNet-aware AF 605 of the request to the NEF 808 to establish an AF session with a required QoS is indicated in FIG. 8 by a single-headed arrow and the reference numeral 812.

In this embodiment, the NEF 808 discovers the PCF 608 serving the UE 400 and sends an Npcf_PolicyAuthorizationRequest to the PCF 608. The Npcf_PolicyAuthorizationRequest may include the UE IP address and TSC Assistance Information. The sending by the NEF 808 of the Npcf_PolicyAuthorizationRequest to the PCF 608 serving the UE 400 is indicated in FIG. 8 by a single-headed arrow and the reference numeral 814.

If the AF 605 includes individual QOS information, the NEF 808 interacts with a Time Sensitive Communication and Time Synchronization Function (TSCTSF) 816 to request establishment of a corresponding session with the QoS requirements. The interacting by the NEF 808 with the TSCTSF 816 and requesting establishment of the corresponding session is indicated in FIG. 8 by a single-headed arrow and the reference numeral 816.

In this case, Steps 3b to 4a as described in FIG. 4.15.6.6-1 in 3GPP TS 23.502 v 17.4.0 take place. Execution of these steps is indicated in FIG. 8 by the reference numeral 818.

The TSCTSF then acknowledges the request made by the NEF 808 at 816. The acknowledging by the TSCTSF of the request made by the NEF 808 is indicated in FIG. 8 by a single-headed arrow and the reference numeral 820.

In this embodiment, the PCF 608 determines PCC rules based on the TSC Assistance Information. The determining by the PCF 608 the PCC rules based on the TSC Assistance Information is indicated in FIG. 8 by the reference numeral 822.

The PCF 608 then acknowledges the Npcf_PolicyAuthorization request received by the NEF 808 at 814. The acknowledging by the PCF 608 the Npcf_PolicyAuthorization request is indicated in FIG. 8 by a single-headed arrow and the reference numeral 824.

In this embodiment, the NEF 808 acknowledges the AF session with a QoS response to the AF 605. The NEF 808 may create the AF session with a QoS response to the AF 605. The acknowledging or creating by the NEF 808 of the AF session with a QoS response is indicated in FIG. 8 with a single-headed arrow and the reference numeral 826.

In this embodiment, the PCF 608 installs updated PCC rules, i.e. a SM Policy Association Update, to the SMF 610 for the PDU Session used for the DetNet flow(s) 204. The installing by the PCF 608 of the updated PCC rules to the SMF 610 is indicated in FIG. 8 by a double-headed arrow and the reference numeral 828.

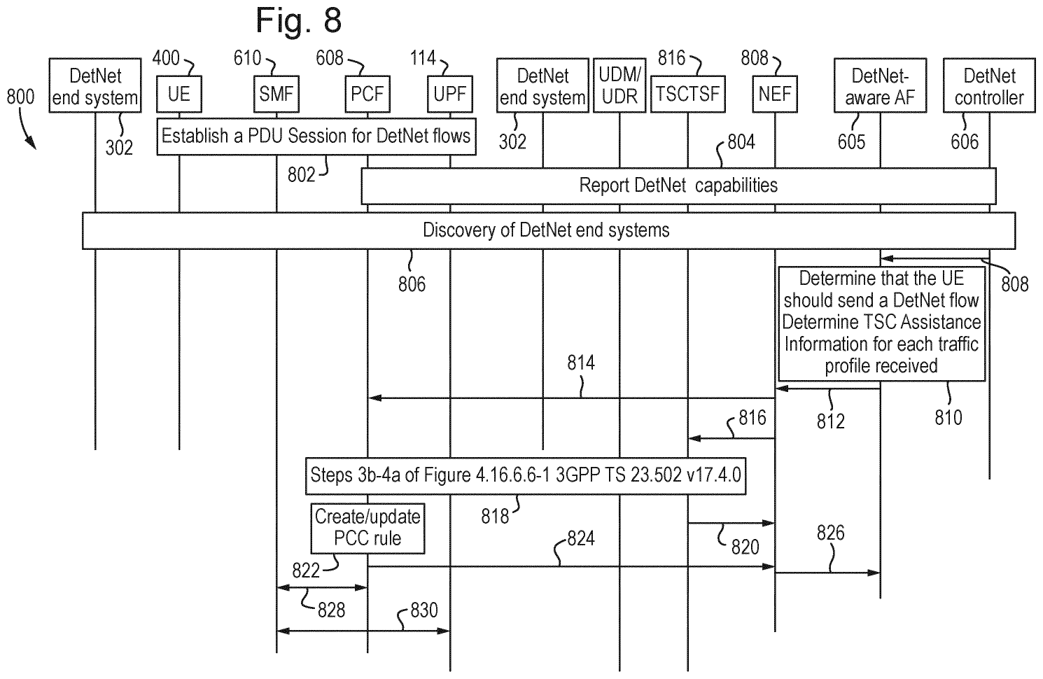

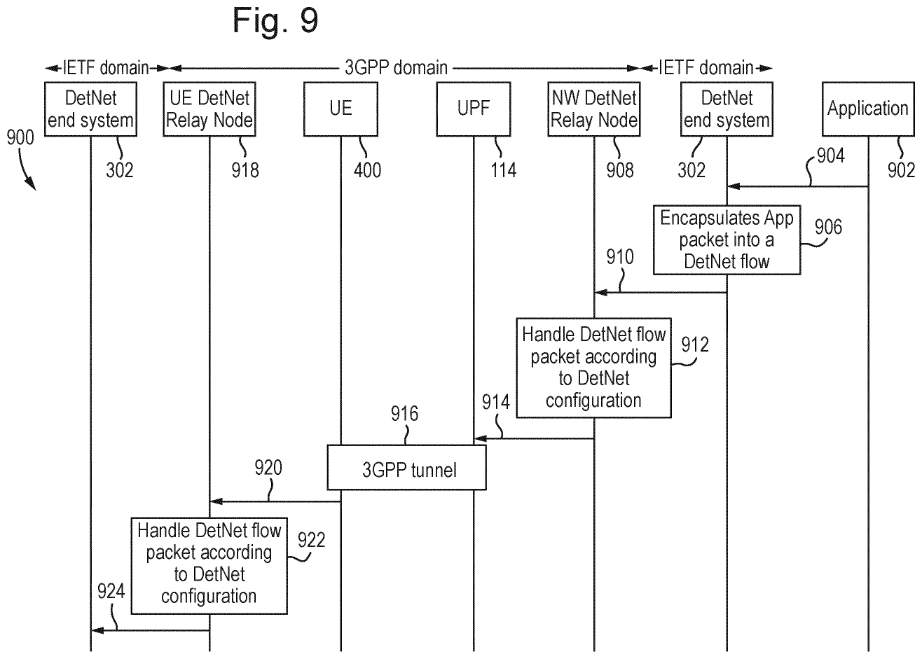

In this embodiment, the SMF 610 installs N4 rules to the UPF 114. The installing by the SMF 610 of the N4 rules to the UPF 114 is indicated in FIG. 8 by a double-headed arrow and the reference numeral 830. ##Once the user plane path has been appropriately configured, i.e. once the DetNet controller 606/DetNet-aware AF 605 receives the response/acknowledgement at 826, the DetNet flow packet traverses the 3GPP domain as shown in FIG. 9.

FIG. 9 depicts a procedure 900 for routing the DetNet flow packet via a DetNet aware 5GS.

In this embodiment, an application 902 sends an application packet to the DetNet end system 302. The sending by the application 902 of the application packet to the DetNet end system is indicated in FIG. 9 by a single-headed arrow and the reference numeral 904.

In this embodiment, the DetNet end system 302 encapsulates the application packet into the DetNet flow 204. The encapsulating by the DetNet end system 302 the application packet into the DetNet flow 204 is indicated in FIG. 9 by the reference numeral 906.

In this embodiment, the DetNet end system 302 sends in the DetNet flow 204 a DetNet flow packet, e.g. an IP packet to a NW DetNet Relay Node 908, e.g. to the NW Relay Node Function 602. The sending by the DetNet end system 302 the DetNet flow packet to the NW DetNet Relay Node 908 is indicated in FIG. 9 by a single-headed arrow and the reference numeral 910.

In this embodiment, the NW DetNet Relay Node 908 handles the DetNet flow packet according to the DetNet configuration information. The handling by the NW DetNet Relay Node 908 of the DetNet flow packet according to the DetNet configuration information is indicated in FIG. 9 by the reference numeral 912.

In this embodiment, the NW DetNet Relay Node 908 sends in the DetNet flow 204 the DetNet flow packet to the UPF 114. The sending by the NW DetNet Relay Node 908 of the DetNet flow packet to the UPF 114 is indicated in FIG. 9 by a single-headed arrow and the reference numeral 914.

In this embodiment, the UPF 114 sends to the UE 400 via a 3GPP tunnel the DetNet flow packet. The sending by the UPF 114 to the UE 400 the DetNet flow packet via the 3GPP tunnel is indicated in FIG. 9 by the reference numeral 916.

In this embodiment, the UE 400 sends in the DetNet flow 204 the DetNet flow packet to a UE DetNet Relay Node 918, e.g. to the UE Relay Node Function 604. The sending by the UE 400 of the DetNet flow packet to the UE DetNet Relay Node 918 is indicated in FIG. 9 by a single-headed arrow and the reference numeral 920.

In this embodiment, the UE DetNet Relay Node 918 handles the DetNet flow packet according to the DetNet configuration information. The handling by the UE DetNet Relay Node 918 of the DetNet flow packet according to the DetNet configuration information is indicated in FIG. 9 by the reference numeral 922.

In this embodiment, the UE DetNet Relay Node 918 sends to the DetNet end system 302 the DetNet flow packet. The sending by the UE DetNet Relay Node 918 to the DetNet end system 302 the DetNet flow packet is indicated in FIG. 9 by the reference numeral 924.

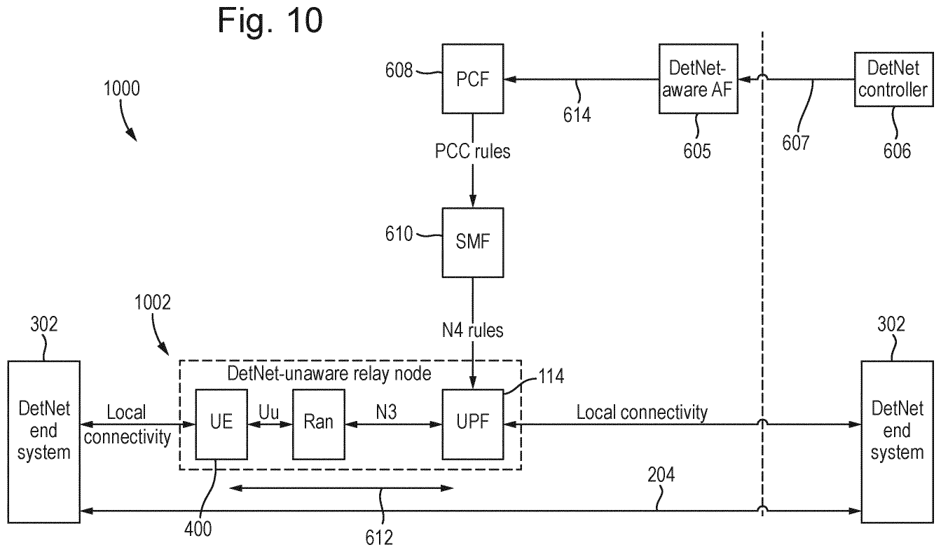

FIG. 10 depicts an alternative embodiment of an architecture 1000 in which DetNet flow 204 is supported via a DetNet-unaware 3GPP system.

In this alternative embodiment, the UE 400 and the UPF 114 are not aware of DetNet flows 204 but the 3GPP system is configured to route a packet that includes a further DetNet flow with QoS requirements which are similar to the QoS requirements of the DetNet flow 204. The UE 400 and the UPF 114 may be considered a DetNet-unaware relay node 1002.

In the architecture 1000, the whole 5GS is configured as a DetNet relay node 306.

In order to support the architecture 1000, the following needs to take place:
The UE establishes a PDU Session 612 as per 3GPP TS 23.502 v 17.4.0. The UE 400 may request to establish a further redundant PDU Session.
The DetNet-aware AF 605 subscribes to be notified of the IP address of the UE 400 that is used for DetNet flows 204.
Discovery of DetNet end systems 302 located behind the relay nodes 306, i.e. behind the UE 400 and the UPF 114.
The DetNet-aware AF 605 receives the DetNet flow configuration information from DetNet controller 606.
Mapping of the DetNet flow configuration information obtained from DetNet controller 606 into 5GS QoS information (e.g. 5QI, TSC Assistance Information) of a QoS flow in the corresponding PDU Session 612 for DetNet flows 204. Mapping of the DetNet flow configuration information by the DetNet-aware AF 605 into 5GS QoS information of a QoS flow is indicated in FIG. 10 by a single-headed arrow and the reference numeral 614, and is in accordance with action 614 described above.

It shall be understood that much of the architecture 1000 corresponds to the architecture 600 described above with reference to FIG. 6. For example, receipt by the DetNet-aware AF 605 of configuration information is indicated in FIG. 10 by a single-headed arrow and the reference numeral 607, and is in accordance with action 607 described above. Where the architecture 1000 includes entities or actions corresponding to those described in the architecture 600, like reference numerals shall be understood to confer the same or similar role to the entities or actions, unless otherwise described.

When the UE 400 establishes the PDU Session 612, the difference in this embodiment to the procedure 700 described in FIG. 7 is that the UE 400 does not report any DetNet capability and the SMF 610 reports to the DetNet-aware AF 605 (corresponding to action 728 in FIG. 7) the IP address of the UE 400. In the corresponding procedure of this embodiment, the UE 400 and the UPF 114 may still report a residence time if the UE 400 and the UPF 114 support, respectively, DS-TT and NW-TT functionality, in which case the residence time is forwarded to the DetNet-aware AF 605. This can be used by the DetNet controller 606 to determine the latency of a packet when it is traverses the 5GS and to determine appropriate QoS for the DetNet flow 204 to traverse the 5GS.

The procedure for the DetNet controller 606 to configure the DetNet-aware AF 605 with QoS requirements is as described in the description of procedure 800 with reference to FIG. 8. At action 810, shown in FIG. 8, the DetNet-aware AF 605 determines the IP address of the UE 400 to initiate, at action 812, an AF session request with specific QOS requirements.

In an embodiment, there is provided a wireless communication device for communicating with a wireless communication network. In this embodiment, the wireless communication device is the UE 400 configured to perform the procedures, and participate in the architectures, described in embodiments above.

A transceiver of the wireless communication device, i.e. the transceiver 425 of the UE 400, is configured to send a request to the wireless communication network, the request comprising a first information to set up a user plane connection for DetNet traffic, i.e. the DetNet flow 204. In this embodiment, the first information includes the configuration information received by the DetNet controller 606 as described in the above embodiments.

The request may be for establishment of a user plane connection, e.g. the PDU Session 612 established in the embodiments above. The request for establishment of the user plane connection is done, in this embodiment, in accordance with the actions 702, 802 described in embodiments above. By transmitting the request comprising the first information to set up a user plane connection for Deterministic Network traffic, the wireless communication device is arranged such that Deterministic Network traffic is carried over the wireless communication network. The first information may comprise at least one requirement.

In this embodiment, the first information may comprise at least one of: a DNN, a S-NSSAI, or both.

In this embodiment, the first information may include a DetNet capability of the wireless communication device, i.e. the DetNet capability of the UE 400 as provided to the PCF 608 in procedure 700 at action 724.

In this embodiment, the DetNet capability of the wireless communication device may define a capability of the wireless communication device to act as at least one of a Relay node, an Edge node, a Transit node, or a combination thereof.

In this embodiment, the DetNet capability of the wireless communication device may include a capability of the wireless communication device to support neighbour discovery protocols and/or DetNet configuration protocols.

In this embodiment, the DetNet capability of the wireless communication device may include a capability to calculate a residence time.

The DetNet may be an IETF DetNet in accordance with the embodiments described above.

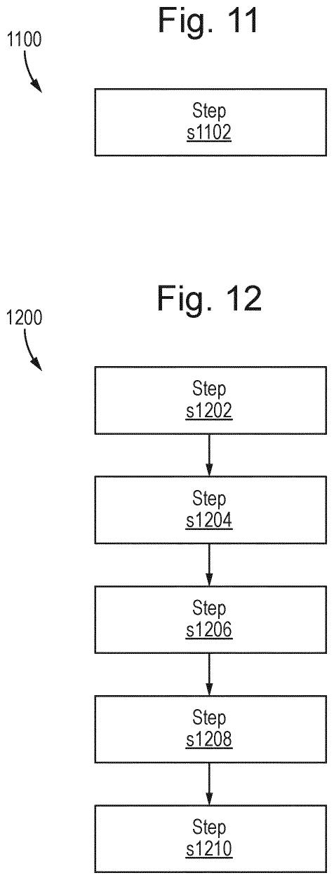

In an embodiment, there is provided a method 1100 performed by the wireless communication device of the above embodiment. FIG. 11 is a process flow chart depicting the method 1100, which includes, at step s1102, sending, by a transceiver of the wireless communication device, i.e. the transceiver 425 of the UE 400, a request to the wireless communication network, the request comprising a first information to set up a user plane connection for DetNet traffic, i.e. the DetNet flow 204.

In an embodiment, there is provided an AF in a wireless communication network. In this embodiment, the AF is in accordance with the DetNet-aware AF 605 described in embodiments above, and in accordance with the network node 500 described above.

The AF comprises a transceiver, in accordance with the transceiver 525, arranged to send a subscription request to a first NF of the wireless communication network, the subscription request requesting a notification of the network address of a device (e.g. the UE 400) when the device establishes a user plane connection to support DetNet deterministic traffic. The first NF is in accordance with the network node 500 described above.

The transceiver is further arranged to receive from the first NF first information, the first information identifying a first device, and the first information identifying a second NF supporting DetNet relay node functionality, i.e. the second NF being configured to perform as a DetNet relay node 306 as described in embodiments above. The second NF is in accordance with the network node 500.

The transceiver is further arranged to receive from a DetNet controller, in accordance with the DetNet controller 606 described in embodiments above, in response to receiving the first information, DetNet flow requirements.

In this embodiment, the AF further comprises a processor, in accordance with the processor 505, arranged to translate DetNet flow requirements into QoS requirements for relating DetNet traffic over the wireless communication network. The translating the DetNet flow requirement into QoS requirements is, in this embodiment, performed in accordance with the mapping 614 of the DetNet flow configuration information obtained from DetNet controller 606 into 5GS QoS information, described in embodiments above.

The transceiver is further arranged to send a second request to the second NF to establish a user plane session with the wireless communication network in accordance with the QoS requirements for relating DetNet traffic over the wireless communication network.

The AF of this embodiment is thus arranged to carry DetNet traffic over the wireless communication network, implementing the DetNet flow requirements (e.g. the DetNet configuration information described in embodiments above) for the DetNet traffic.

The DetNet flow requirements may be QoS requirements from the DetNet. The QoS requirements for relaying DetNet traffic over the wireless communication network may be 3GPP QOS requirements.

The processor may be arranged to translate the DetNet flow requirements into QoS requirements for relaying DetNet traffic over the wireless communication network dependent upon information provided by the first device and/or the second NF. The information may comprise, for example, a residence time.

The first NF may be a NEF, e.g. the NEF 808 described above with reference to FIG. 8.

The second NF may be a UPF, e.g. the UPF 114 described in embodiments above.

The DetNet may be an IETF DetNet in accordance with the embodiments described above.

In an embodiment, there is provided a method 1200 performed by the AF of the above embodiment. FIG. 12 is a process flow chart depicting the method 1200. The method includes, at step s1202, sending a subscription request to the first NF of the wireless communication network, the subscription request requesting a notification of the network address of a device when the device established a user plane connection to support DetNet deterministic traffic.

The method includes, at step s1204, receiving from the first NF first information, the first information identifying a first device, and the first information identifying a second NF supporting DetNet relay node functionality, i.e. the second NF being configured to perform as a DetNet relay node 306 as described in embodiments above. The second NF is in accordance with the network node 500.

The method includes, at step s1206, receiving from a DetNet controller, in accordance with the DetNet controller 606 described in embodiments above, in response to receiving the first information, DetNet flow requirements.

The method includes, at step s1208, translating the DetNet flow requirements into QoS requirements for relaying DetNet traffic over the wireless communication network. The translating the DetNet flow requirement into QoS requirements is, in this embodiment, performed in accordance with the mapping 614 of the DetNet flow configuration information obtained from DetNet controller 606 into 5GS QoS information, described in embodiments above.

The method includes, at step s1210, sending a second request to the second NF to establish a user plane session with the wireless communication network in accordance with the QOS requirements for relaying DetNet traffic over the wireless communication network.

Thus, a method 1200 is provided for arranging an AF to carry DetNet traffic over the wireless communication network, implementing the DetNet flow requirements (e.g. the DetNet configuration information described in embodiments above) for the DetNet traffic.

In an embodiment, there is provided a first NF in a wireless communication network, the first NF comprising a transceiver, i.e. the transceiver 525, arranged to receive a subscription request from an AF of the wireless communication network, the subscription request requesting a notification of the network address of a device when the device establishes a user plane connection to support DetNet deterministic traffic. The first NF is in accordance with the network node 500 described above.

In this embodiment, the transceiver is arranged to send to the AF a first information, the first information identifying a first device, and the first information identifying a second NF supporting DetNet relay node functionality, i.e. the second NF being configured to perform as a DetNet relay node 306 as described in embodiments above. The second NF is in accordance with the network node 500.

The first NF may be a NEF, e.g. the NEF 808 described above with reference to FIG. 8.

The DetNet may be an IETF DetNet in accordance with the embodiments described above.

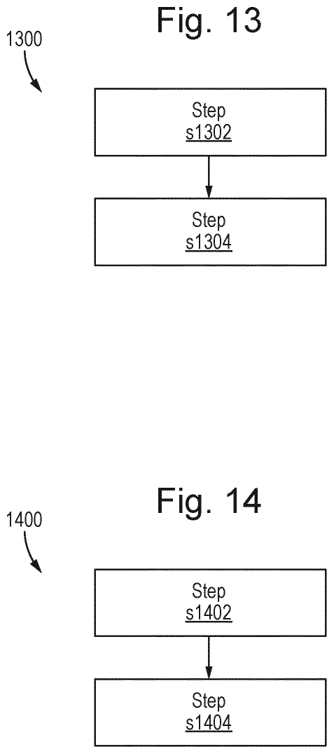

In an embodiment, there is provided a method 1300 performed by the first NF of the above embodiment. FIG. 13 is a process flow chart depicting the method 1300. The method includes, at step s1302, receiving a subscription request from an AF of the wireless communication network, the subscription request requesting a notification of the network address of a device when the device establishes a user plane connection to support DetNet deterministic traffic. The first NF is in accordance with the network node 500 described above.

The method includes, at step s1304, sending to the AF a first information, the first information identifying a first device, and the first information identifying a second NF supporting DetNet relay node functionality, i.e. the second NF being configured to perform as a DetNet relay node 306 as described in embodiments above. The second NF is in accordance with the network node 500.

In an embodiment, there is provided a UPF in a wireless communication network, the UPF being in accordance with the UPF 114 described in embodiments above, and being in accordance with the network node 500. The UPF comprises a transceiver, i.e. the transceiver 525, arranged to receive, from a SMF in accordance with the SMF 610 described in embodiments above, a request to establish a user plane session with the wireless communication network in accordance with at least one QoS requirement for relaying DetNet traffic over the wireless communication network.

In this embodiment, the transceiver is further arranged to transmit a response to the SMF indicating first information including a DetNet capability of the UPF. The first information may be transmitted in a container.

In an embodiment, there is provided a method 1400 performed by the UPF of the above embodiment. FIG. 14 is a process flow chart depicting the method 1400. The method includes, at step s1402, receiving, from a SMF in accordance with the SMF 610 described in embodiments above, a request to establish a user plane session with the wireless communication network in accordance with at least one QoS requirement for relaying DetNet traffic over the wireless communication network.

The method 1400 includes, at step s1404, transmitting a response to the SMF indicating first information including a DetNet capability of the UPF. The first information may be transmitted in a container.

Thus, a method 1400 is provided for arranging a UPF to carry DetNet traffic over the wireless communication network (i.e. to act as a DetNet relay node), implementing the DetNet flow requirements (e.g. the DetNet configuration information described in embodiments above) for the DetNet traffic.

Advantageously, the methods and apparatuses described herein tend to integrate support of DetNet using IETF DetNet specifications via the 5GS. The solution tends to allow a DetNet controller to discover nodes within the 3GPP system which are DetNet-aware, and to allow the controller to provide requirements such that the 3GPP network may establish a user plane connection with QoS requirement meeting the QoS criteria of a DetNet flow.

Advantageously, the methods and apparatuses describe herein overcome existing problems of how to identify and discover UEs which support establishment of a user plane connection for DetNet traffic and how to configure a 3GPP system, e.g. existing 3GPP systems, to support a user plane connection for DetNet traffic.

While in some embodiments described above the 3GPP system is configured to support DetNet traffic is DetNet aware (with DetNet-aware nodes, e.g. the UE and UPF, acting as relay nodes), in other arrangements the 3GPP system is DetNet-unaware, yet can, advantageously, support DetNet flow. In particular, in DetNet-unaware 3GPP systems, the network may advantageously be set up to route DetNet flows with specific QOS requirements, thereby to fulfil the IETF QOS requirements of DetNet flow.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
transmit a request to a wireless communication network, the request comprising a first information to setup a user plane connection for Deterministic Network (DetNet) data traffic.

2. The UE of claim 1, wherein the first information comprises at least one of a data network name or a single network slice selection assistance information.

3. The UE of claim 1, wherein one of the first information corresponds to a DetNet, or the first information includes a DetNet capability of the UE.

4. (canceled)

5. The UE of claim 3, wherein the DetNet capability of the UE defines the UE to act as at least one of a relay node, an edge node, or a transit node.

6. The UE of claim 3, wherein the DetNet capability of the UE includes a capability to support one or more of neighbor discovery protocols or DetNet configuration protocols.

7. The UE of claim 3, wherein the DetNet capability of the UE includes a capability to calculate a residence time.

8-9. (canceled)

10. A network node implementing an application function in a wireless communication network, the network node comprising:
at least one memory; and
at least one processor coupled with the at least one memory and configured to cause the network node to:
send a subscription request to a first network function of the wireless communication network, the subscription request requesting a notification of a network address of a user equipment (UE) that establishes a user plane connection to support Deterministic Network (DetNet) deterministic data traffic;
receive, from the first network function, first information identifying a first device, and the first information identifying a second network function supporting DetNet relay node functionality;
receive, from a DetNet controller in response to receiving the first information, DetNet flow requirements, the application function configured to translate the DetNet flow requirements into quality of service (QOS) requirements for relaying the DetNet deterministic data traffic over the wireless communication network; and
send a second request to the second network function to establish a user plane session with the wireless communication network in accordance with the QoS requirements for relaying the DetNet deterministic data traffic over the wireless communication network.

11. The network node of claim 10, wherein the at least one processor is configured to cause the application function to translate the DetNet flow requirements into the QoS requirements for relaying the DetNet deterministic data traffic over the wireless communication network dependent upon second information provided by one or more of the first device or the second network function.

12. The network node of claim 10, wherein the first network function is a network exposure function.

13. The network node of claim 10, wherein the second network function is a user plane function.

14. The application function of claim 10, wherein the DetNet is an IETF DetNet.

15. A method performed by a network node implementing an application function of a wireless communication network, the method comprising:
sending a subscription request to a first network function of the wireless communication network, the subscription request requesting a notification of a network address of a user equipment (UE) that establishes a user plane connection to support Deterministic Network (DetNet) deterministic data traffic;
receiving, from the first network function, first information identifying a first device, and the first information identifying a second network function supporting DetNet relay node functionality;
receiving, from a DetNet controller in response to the first information, DetNet flow requirements;
translating the DetNet flow requirements into quality of service (QOS) requirements for relaying the DetNet deterministic data traffic over the wireless communication network; and
sending a second request to the second network function to establish a user plane session with the wireless communication network in accordance with the QoS requirements for relaying the DetNet deterministic data traffic over the wireless communication network.

16-21. (canceled)

22. The method of claim 15, further comprising translating the DetNet flow requirements into the QoS requirements for relaying the DetNet deterministic data traffic over the wireless communication network dependent upon second information provided by one or more of the first device or the second network function.

23. The method of claim 15, wherein the first network function is a network exposure function.

24. The method of claim 15, wherein the second network function is a user plane function.

25. A processor for wireless communication, comprising:
at least one controller coupled with at least one memory and configured to cause the processor to:
transmit a request to a wireless communication network, the request including a first information to setup a user plane connection for Deterministic Network (DetNet) data traffic.

26. The processor of claim 25, wherein the first information includes at least one of a data network name or a single network slice selection assistance information.

27. The processor of claim 25, wherein one of the first information corresponds to a DetNet, or the first information includes a DetNet capability of a user equipment (UE).

28. The processor of claim 27, wherein the DetNet capability of the UE defines the UE to act as at least one of a relay node, an edge node, or a transit node.

29. The processor of claim 27, wherein the DetNet capability of the UE includes a capability to support one or more of neighbor discovery protocols or DetNet configuration protocols.
